(19) United States
(12) Patent Application Publication
(10) Pub. No.: US 2024/0086690 A1
(43) Pub. Date: Mar. 14, 2024

(54) SPIKE EVENT DECISION-MAKING DEVICE, METHOD, CHIP AND ELECTRONIC DEVICE

(71) Applicants: Chengdu SynSense Technology Co., Ltd., Sichuan (CN); ShenZhen SynSense Technology Co., Ltd., Shenzhen (CN)

(72) Inventors: Peng ZHOU, Sichuan (CN); Yannan XING, Sichuan (CN); Ning QIAO, Shenzhen, Guangdong (CN); Yudi REN, Sichuan (CN); Zheng KE, Sichuan (CN); Yalun HU, Sichuan (CN); Bo LI, Sichuan (CN); Yuhang LIU, Sichuan (CN); Xiwen GONG, Sichuan (CN); Sadique UI Ameen SHEIK, Schlieren (CH); Dylan RICHARD MUIR, Zurich (CH); Tugba DEMIRCI, Glattpark (CH)

(73) Assignees: Chengdu SynSense Technology Co., Ltd., Sichuan (CN); ShenZhen SynSense Technology Co., Ltd., Shenzhen (CN)

(21) Appl. No.: 18/270,888

(22) PCT Filed: Jan. 14, 2022
(86) PCT No.: PCT/CN2022/072038

§ 371 Date: Jul. 5, 2023

(30) Foreign Application Priority Data
Dec. 6, 2021 (CN) 202111476156.3

(51) Int. Cl. G06N 3/049; G06N 3/063

(52) U.S. Cl. CPC G06N 3/049; G06N 3/063

(57) ABSTRACT

The present disclosure relates to a spike event decision-making device, method, chip, and electronic device to eliminate inherent delays of an output spike event of the neuromorphic chip when reading decisions. The spike event decision-making device includes a first counting module configured to count a number of input spike events of the spiking neural network, a second counting module configured to count some or all of the output spike events of the spiking neural network; and a decision-making module configured to generate a decision-making result according to numbers of spike events fired by neurons in an output layer of the spiking neural network when the number counted by the first counting module reaches a first predetermined value, or when the total count counted by the second counting module reaches a second predetermined value.

This application claims the priority of Chinese Patent Application No. 20211476156.3, entitled “PULSE EVENT DECISION-MAKING APPARATUS AND METHOD, CHIP, AND ELECTRONIC DEVICE”, filed on Dec. 6, 2021, the disclosure of which is incorporated herein by reference in its entirety.

### TECHNICAL FIELD

The present disclosure relates to a spike event decision-making device, a related method, a related chip and a related electronic device, in particular to a spike event decision-making device, a related method, a related chip and a related electronic device, which could self-adaptively make decisions according to event generated speed in an Internet of Things (IoT) edge side.

### BACKGROUND

“Neuromorphic Computing” is a new type of computing architecture. This computing method uses bionic (eye, brain, etc.) methods to complete inference on input signals, breaking through the von Neumann architecture for the first time. Event imaging devices, including but not limited to dynamic vision sensors, generate spike events according to the brightness changes at the corresponding pixel positions and are in a silent state when there is no brightness change. Thus, the event imaging devices do not generate redundant data. This event-driven method is completely different from the frame-based image processing logic.

The neuromorphic chip, commonly known as the brain-inspired chip, is deployed with a novel neural network, which is the latest generation of neural network—Spiking Neural Networks (SNN). Neurons in traditional Artificial Neural Networks (ANN) are computing units based on mathematical functions, while neurons in spiking neural networks are more bionic. If the accumulated membrane voltage (memory) of the input exceeds the threshold (sparsity), it will fire spikes (bionic), which is highly similar to the dynamic characteristics of biological neurons.

Because neuromorphic computing is highly bionic, it also has the ultra-low power consumption characteristics of biological brains, which coincides with the demand for edge computing in the Internet of Things (IoT). Since it is deployed at the IOT edge, it naturally has low latency advantages compared to cloud solutions, and the extremely ultra-low latency for information processing is also the goal of the neuromorphic computing. In addition, the accuracy of inference results is also a basic and core performance indicator.

However, there are still some unreasonable inherent delays (FIG. 1) in the prior art. Eliminating these delays will help the chip/system to obtain decision results faster and make more timely responses for the subsequent system to get more time. In addition, because of this inherent delay, the inference results of the chip may be unreliable in some cases. Therefore, reducing the processing delay of the chip to implement ultra-low delay decision-making and/or raising the reliability of inference results of the chip could be one of the technical adjectives in this field.

### SUMMARY

One objective of an embodiment of the present disclosure is to provide a spike event decision-making device, a related method, a related chip and a related electronic device to reduce the processing delay and/or raise the reliability of inference results of the chip.

According to an embodiment of the present disclosure, a spike event decision-making device, configured to make a decision based on output spike events of a spiking neural network in the neuromorphic chip is disclosed. The spike event decision-making device comprises: a first counting module, configured to count a number of input spike events of the spiking neural network; and a decision-making module is configured to generate a decision-making result according to numbers of spike events fired by a plurality of neurons in an output layer of the spiking neural network when the number counted by the first counting module reaches a first predetermined value. Wherein the plurality of neurons are part or all neurons in the output layer.

In some embodiments, the spike event decision-making device further comprises a second counting module, configured to perform one of following operations to count the numbers of spike events fired by the plurality of neurons in the output layer of the spiking neural network: (i) counting spikes fired by each neuron in the output layer, and adding them up to obtain a total count of the spikes fired by a part or all neurons in the output layer; (ii) counting spikes fired by a plurality of neurons in the output layer to obtain the total count; and (iii) counting spikes fired by each neuron in the output layer without adding them up.

In some embodiments, the decision-making module is further configured to make a decision when the number counted by the first counting module reaches the first predetermined value or when the count of the first count module reaches the first predetermined value and when a number counted by the second counting module reaches a second predetermined value.

In some embodiments, when there are at least two successive decision-making results, there is a partial overlap between the input spike events corresponding to the two corresponding numbers counted by the first counting module; and/or, there is partial overlap between the spike events fired by the neurons in the output layer of the spiking neural network corresponding to the two corresponding numbers counted by the second counting module.

In some embodiments, the second counting module uses a plurality of sub-counter to count spike events fired by each of the plurality of neurons in the output layer, to remove an earliest count in the sub-counter, and to use a zeroed sub-counter to count new spike events. A sum of counts in all sub-counters corresponding to each neuron in the output layer is used as a count on which the decision-making result is based.

In some embodiments, when a plurality of successive decision-making results meet one or a plurality of conditions below, then outputting a decision-making result with the largest number of occurrences in the successive decision-making results: (i) when a transition rate or a number of transitions of the successive decision-making results is lower than a first threshold; and (ii) when a ratio of the decision result with the most occurrences to the successive decision-making results is higher than a second threshold; otherwise, stopping outputting any decision result or outputting the decision result with an uncertain indication result.

In some embodiments, one or more of the first counting module, the second counting module, and the decision-making module is implemented inside or outside the neuromorphic chip.

In some embodiments, one or more of the first counting module, second counting module, and a decision-making module in the spike event decision-making device are implemented within or outside the neuromorphic chip.

According to another embodiment, a spike event decision-making device configured to make a decision based on output spike events of a spiking neural network in a neuromorphic chip is provided. The spike event decision-making device includes a second counting module, configured to count some or all of the output spike events of the spiking neural network, and a decision-making module, configured to generate a decision-making result according to counts of spike events fired by each of neurons in an output layer of the spiking neural network when a total count of the second counting module reaches a second predetermined value.

In some embodiments, the second counting module is further configured to use a plurality of sub-counters to count the spike events fired by each of the neurons in the output layer, to remove an earliest count in a sub-counter, and use a zeroed sub-counter to count new spike events; and a sum of counts in all sub-counters corresponding to each neuron in the output layer is used as a count on which the decision-making result is based.

On some embodiments, when a plurality of successive decision-making results meet one or a plurality of conditions below, then outputting a decision-making result with a largest number of occurrences in the successive decision-making results: (i) when a transition rate or a number of transitions of the successive decision-making results is lower than a first threshold; and (ii) when a ratio of the decision result with the most occurrences to the successive decision-making results is higher than a second threshold; otherwise, stopping outputting any decision result or outputting the decision result with an uncertain indication result.

In some embodiments, one or more of the second counting module and the decision-making module is implemented inside or outside the neuromorphic chip.

According to an embodiment of the present disclosure, a spike event decision-making method, configured to make a decision based on output spike events of a spiking neural network in a neuromorphic chip is disclosed. The method comprises: counting a number of input spike events of the spiking neural network to obtain a first count value; and generating a decision-making result according to counts of spike events of each of a plurality of neurons in an output layer of the spiking neural network when the first count value reaches a first predetermined value; or counting a number of output spike events of some or all neurons in the output layer of the spiking neural network to obtain a second count value; and generating a decision-making result according to counts of spike events of each of the neurons in an output layer of the spiking neural network when the second count value reaches a second predetermined value.

In some embodiments, there is at least a partial overlap between the input spike events corresponding to the first count value obtained twice when two adjacent decision-making results are made; or/and, use a plurality of sub-counter to count each spike event emitted by some or all neurons of the output layer; Remove the earliest count in the sub-counter, and use the zeroed sub-counter to count the newly issued spike events; The sum of counts in all sub-counters corresponding to each neuron in the output layer is used as the count on which the decision result is based.

The spike event decision-making device may be distributed in a plurality of different physical devices (e.g., chips), jointly complete the decision-making function.

According to another embodiment, a chip deploying a spike neural network is provided. The chip includes a spike event decision-making device as provided above, and a time-window-based decision-making device, and the chip is configured to allow selection between the spike event decision-making device and time-window-based decision-making device.

According to another embodiment, an electronic device includes an event imaging device and a spike event decision-making device as provided above or a chip as provided above, or performs a spike event decision-making method as provided above. The spike event decision-making device, the chip or the spike event decision-making method is configured to make decisions on the output spike event processed by the event imaging device.

A spiking neural network training method includes: constructing a plurality of images according to a fixed number of spike events for a data set collected by an event imaging device; training an artificial neural network according to the plurality of images; converting the artificial neural network into a spiking neural network; deploying the converted spiking neural network to neuromorphic chip.

A part or all of embodiments of the present disclosure could have at least the following beneficial effects:
1. The final decision result can be determined according to the speed of the event;
2. Eliminate inherent delays and raise response efficiencies;
3. Avoid affecting decision-making accuracy due to an insufficient number of spike events;
4. The sliding counting window can effectively improve the overall reliability of the decision-making results.

More beneficial effects will be described in the following preferred embodiments.

The above-mentioned techniques, technical features, and technical means might not be completely the same as those in parts of the following embodiments. However, these techniques also fall within the scope of the present disclosure. These techniques, technical features, and technical means and those disclosed in the following embodiments could be reasonably combined to accomplish more techniques, which could be regarded as beneficial supplements of the embodiments. Similarly, some details in the figures in this disclosure might not be illustrated in detail. But if one of ordinary skills in the art could infer the techniques from the related disclosure, corresponding descriptions, common knowledge in this field, or other conventional techniques (such as conferences or papers), then these details also fall within the scope of the present disclosure. In addition, these details could be also used to combine with other techniques to obtain new techniques. The techniques generated by combining technical features disclosed in the present disclosure could be used to support the summary of the techniques, the amendments, the claims or the disclosure of this patent application.

### BRIEF DESCRIPTION OF THE DRAWINGS

The following drawings are only examples of some of the technical solutions disclosed in the present disclosure. Other technical solutions are not exhaustively described in text form, and the drawings corresponding to these solutions can reasonably be inferred. The present disclosure is not necessarily limited by these drawings.

FIG. 1 is a diagram of a conventional time window-based scheme.

FIG. 2 is a diagram of a low-latency decision-making device according to an embodiment of the present disclosure.

FIG. 3 is a diagram of a sliding counting window scheme according to an embodiment of the present disclosure.

FIG. 4 is a diagram of a multi-window counting scheme of the second counting module according to an embodiment of the present disclosure.

FIG. 5 is a diagram of a decision-making scheme according to an embodiment of the present disclosure.

FIG. 6 is a diagram of a high-frequency decision-making results that cannot pass through a low-pass filter according to an embodiment of the present disclosure.

FIG. 7 is a diagram of a low-frequency decision-making results that pass through a low-pass filter according to an embodiment of the present disclosure.

FIG. 8 a diagram of a training scheme matching count-based decisions.

### DETAILED DESCRIPTION

Other technical solutions and details not disclosed in detail below, generally belong to the conventional technical means/common knowledge in the art. The present disclosure does not describe it in detail.

Unless it is the meaning of division, the symbol “/” anywhere in the present disclosure indicates a logical “or”. In addition, the terms “first”, “second”, “third” anywhere in the present disclosure are used only as distinguishing marks in descriptive purposes and do not imply an absolute order in time or space, nor do they imply that terms bearing such ordinals are necessarily different references from the same terms with other determiners.

The various modules of the present disclosure (and the apparatus having the modules) may be implemented by hardware, such as FPGA, ASIC or other IC design components. Through an interface circuit between a sensor and a processor, the modules may be designed in the same die or in different dies, or implemented by a combination of software and hardware, The realization of the technical solution described in the present disclosure may take different physical embodiments, and the present disclosure does not limit the specific embodiment.

The steps and modules anywhere in the present disclosure do not imply that such existence is the exclusive only existence. Those skilled in the art may understand other technical solutions according to the technical solutions disclosed in the present disclosure supplemented by other technical means. Such solutions are not separated from the idea of the present disclosure and are within the scope of the present disclosure. To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

In conventional technology, the system makes decisions based on the time window, and the time window means that there will be an inherent delay in the entire solution.

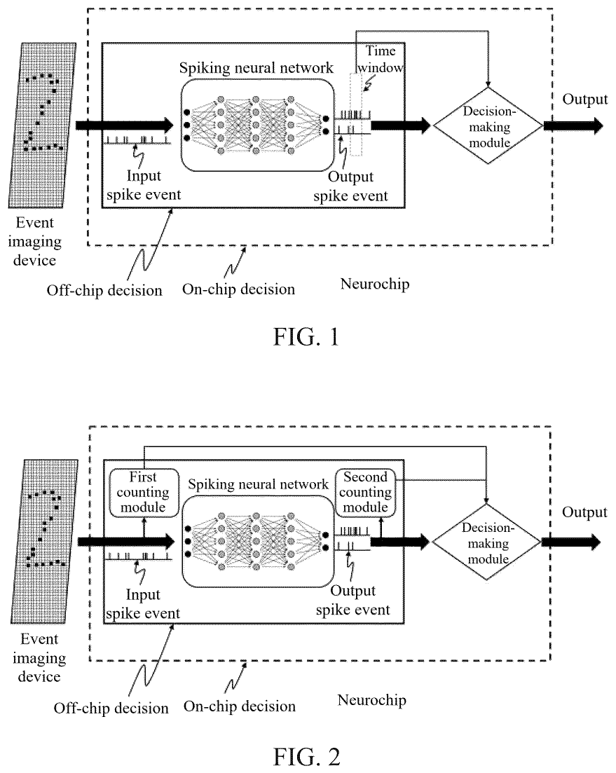

Please refer to FIG. 1. FIG. 1 is a diagram of a conventional time window-based scheme. An event imaging device, such as a dynamic vision sensor, senses changes in ambient signals and generates a sparse input spike (pulse) train. These spike events are fed into the neuromorphic chip, which has a large number of simulated synapses, neuron circuits and other auxiliary circuits. These spike events are sent to the spiking neural network, and the spike events are issued and transmitted in order according to the configured spiking neural network. At the front end of the network, there is an input layer. The leftmost example of the spiking neural network in FIG. 1 shows neurons represented by 3 black circles to form the input layer. At the end of the network, there is an output layer. The output layer comprises several neurons, which also output spikes or pulse trains. The rightmost example of the spiking neural network in FIG. 1 shows neurons represented by 2 black circles to form the output layer. Between the input layer and the output layer, several hidden layers may be included. In FIG. 1, the spiking neural network exemplarily shows neurons represented by gray circles to form 3 hidden layers. The technical solution based on the time window usually sets a time window (such as 100 ms, 10 ms, 2 ms, etc.), reads the counted numbers of spikes or spike events fired by each neuron in the output layer within the time window, and these counted number or the output of the neuron is sent to the decision-making module to make a decision. Decision-making strategies may be different, and the present disclosure is not limited to a specific decision-making strategy.

The time window means that there will be an inherent delay (or delay). Especially when the time window is large, this delay may cause the solution to not match the scene requirements. For example, in autonomous driving scenarios, an extremely short response time is required for the detection of foreign objects such as pedestrian intrusion and rolling stones. That is, for events that occur faster, if the time window is longer at this time, the inference result will be slower to output the decision result due to the inherent time window. In this way, it is difficult to meet the demand for lower latency.

This solution may have another issue: the speed of the event can be fast or slow, such as waving hands can be slow or fast, and it varies from time to time and from person to person. For example, for actions/events that occur slowly, if the time window is relatively short, the data volume of the output spike event during this period may be insufficient. Since a decision must be made within this short period of time, the inference accuracy and the inference result might not be reliable.

Therefore, the present disclosure proposes a counting-based decision-making device, a related method, a related chip and an electronic device.

Please refer to FIG. 2. FIG. 2 is a diagram of a low-latency decision-making device according to an embodiment of the present disclosure. An event imaging device, such as DVS (taken as an example in the following disclosure), receives the change of brightness brought by the target subject in the environment, converts this change into a spike event (or a pixel event, a spike), and transfers the spike event to a neuromorphic chip through a transmission scheme such as USB interface. In a preferred embodiment, DVS is integrated with the neuromorphic chip form an overall solution, which can reduce signal jitters caused by USB transmission. For details, please at least refer to other patent applications of the applicant (such as CN2021110755934). That disclosure is hereby incorporated by reference in its entirety into this application. In the present disclosure, regardless of whether the event imaging device is integrated into the chip, the chip could be regarded as a neuromorphic chip as long as the chip has the spiking neural network.

For the neuromorphic chip, after receiving the spike events fired by the event imaging device, in an embodiment, the number of input spike events of the spiking neural network is counted by the first counting module. The counting technology is a well-known technology in the art. Here, this can be implemented by software, hardware or a combination of software and hardware, which can be implemented in the chip or outside the chip. These changes all fall within the scope of the present disclosure. The neuro chip receives input spike events and sends the spike events to the spiking neural network. The spiking neural network performs an inference process on the input spike events and transmits information to the output layer (a collection of several neurons) of the spiking neural network. The spiking neural network here is built based on various hardware circuits (such as synaptic circuits and neuron circuits) and specific neural network models to organize and manage these neuron circuits and synaptic circuits. For example, a spiking neural network includes an input layer, a hidden layer, and an output layer. The leftmost part of the spiking neural network in FIG. 2 has neurons represented by three black circles to form the input layer. The rightmost part of the spiking neural network in FIG. 2 has neurons represented by 2 black circles to form the output layer. The neurons represented by gray circles form 3 hidden layers in the middle of the spiking neural network.

After the inference operation of the spiking neural network, the spike train is fired through several neurons in the output layer. Each spike in a spike train typically carries the address of the neuron that fires the spike. In the aforementioned scheme based on the time window, the counts of all spike addresses (different addresses correspond to different neurons in the output layer) that output spikes within the time window are counted. That is, the number of spike events that are respectively fired by several neurons in the output layer of the spiking neural network is counted and then the decision-making module could make a decision accordingly.

For example, within the time window, the result corresponding to the neuron with the largest number of outputting spikes is used as the decision-making result.

In an embodiment, the first counting module counts the number of input spike events of the spiking neural network (including a condition that the spike events that enters the neuromorphic chip may not entirely enter the spiking neural network). The input spike events can be generated by the event imaging device but preprocessed by a filtering process, an image segmentation process, etc., or can be input spike events generated by the event imaging device without preprocessing. (In this case, the input spike events of the neural network are substantially the same as the input spike events of the neuromorphic chip). These changes all fall within the scope of the present disclosure.

In an embodiment, the second counting module counts the spikes fired by some or all neurons in the output layer. The counting method of the second counting module can be at least: (1) respectively counting the spikes fired by each neuron in the output layer, and then adding them up to obtain the total count of the spikes emitted by some or all neurons in the output layer; (2) directly counting all the spikes issued by some or all neurons of the output layer to obtain the total count; (3) Counting the spikes fired by each neuron in the output layer separately without adding them up. Different counting methods are used in different embodiment to match different needs. The total count here may be the counted number of the spikes fired by a part of the output layer (for example, due to some special needs) or all the spiking neurons, but it is preferably the count of the spikes fired by all the spiking neurons in the output layer. In other words, the total count (counted number) of the second counting module is the sum of the counts of spike events of some or all neurons in the output layer.

In an embodiment, the first counting module and/or the second counting module are implemented in the neuromorphic chip (counting in the chip). In another embodiment, the first counting module and/or the second counting module are implemented outside the neuromorphic chip (counting outside the chip). In a preferred embodiment, both the first counting module and the second counting module are implemented in the neuromorphic chip.

In an embodiment, the spike event decision-making device may only have the above-mentioned second counting module (this solution is not shown in the figure), or preferably both the first counting module and the second counting module (shown in FIG. 2).

Based on the counted number of the first counting module and/or the second counting module, the decision-making module is triggered to make a decision. For example, when the number counted by the first counting module reaches a first predetermined value, or in another type of embodiment, when the total count of the second counting module reaches a second predetermined value, the decision-making module is triggered to make a decision.

In an embodiment, the first counting module counts the input spike events of the spiking neural network. When the count value reaches the first predetermined value θ1, the counted numbers of the spike events fired by different neurons in the output layer are respectively obtained (which can be the third counting method of the second counting module). Based on the obtained counted numbers, a decision-making result is generated in the decision module. For example, the result corresponding to the neuron with the largest number of spikes in the output layer may be used as the decision-making result, such as a first category corresponding to the first neuron and/or a second category corresponding to second neuron.

In an embodiment, the second counting module counts the spike events fired by some or all neurons in the output layer (for example, the first and second counting methods of the second counting module), if the total counted number reaches the second predetermined value θ2, the counted numbers of spike events fired by several neurons in the output layer are obtained respectively, and the decision-making module makes a decision based on the obtained counted numbers.

In this way, the counting-based decision-making mechanism can realize: When the target subject moves faster at the same position in the DVS receptive field, more spike events are generated per unit time, so the counting of the first counting module and/or the second counting module could reach the corresponding first predetermined value or second predetermined value sooner, then the decision-making module can obtain the output reasoning result in time, which can break the inherent delay of the time window. When the target subject moves slowly at the same position of the DVS receptive field, fewer spike events are generated per unit time, so the counting of the first counting module or/and the counting of the second counting module are slower to reach the corresponding first predetermined value or the second predetermined value. This overcomes the defect that the number of spike events counted/accumulated by the decision-making module in the fixed time window is insufficient and the inference result is inaccurate.

As for the specific implementation of the decision-making module, it may be any reasonable decision-making logic, which is not limited in this application. The decision-making module can be implemented as decision-making inside the chip or outside the chip. The so-called “decision-making inside the chip” means that the inference is completed inside the neuromorphic chip, and the decision-making result or inference results are provided. The “decision-making outside the chip” means that the chip only completes the interference process of the neural network, and transmits the spike events fired by the spike neurons in the output layer to the outside of the chip, CPU, etc.) to complete the decision-making process.

In fact, the decision-making module (some embodiment also includes low-pass filter), the first counting module, the second counting module, etc. in the spike event decision-making device can be partially or completely implemented inside or outside a chip according to actual needs. In addition, the spike event decision-making device may be independently implemented in the neuromorphic chip or dispersed in different physical components. These changes fall within the scope of the present disclosure. The solution inside the chip or outside the chip can be selected according to the characteristics of the chip and the needs of actual application scenarios. For example, a neuromorphic chip may not support the counting-based decision-making solution of the present disclosure, but it can implement the self-adaptive decision-making solutions of the present disclosure through the solution outside the chip. These changes fall within the scope of the present disclosure.

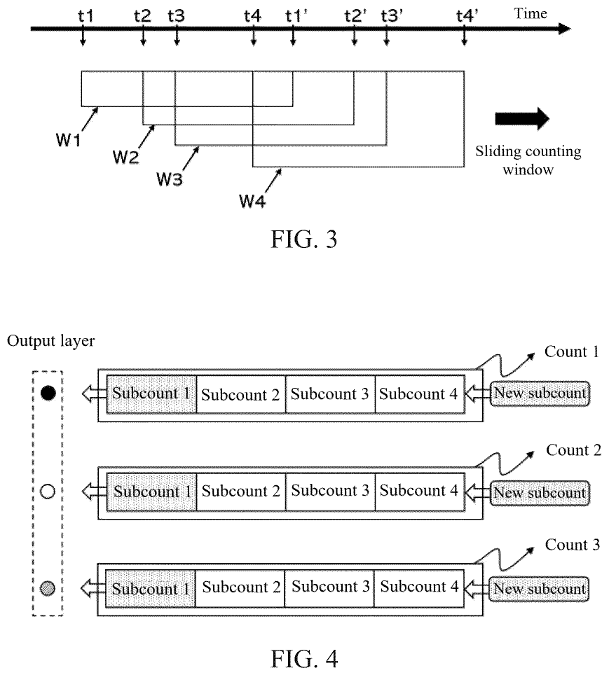

Please refer to FIG. 3. FIG. 3 shows an improved structure according to an embodiment of the present disclosure. In this embodiment, a sliding counting window is introduced to take into account the temporal correlation. During the time period t1-t1′, the first counting window W1 completes a cumulative count. At the time t1′, a decision is made. After that, the counted numbers (the counted number of the first counting module or the total counted number of the second counting module) are not cleared or reset to zero, but a certain number (fixed or floating, such as θ₁/4, θ₂/4) is subtracted. The counting continues. As for the counted numbers of spike events fired by different neurons in the output layer, the necessary adaptation also needs to be made to adapt to the window sliding.

Please refer to FIG. 4. FIG. 4 is a diagram of a multi-window counting scheme of the second counting module according to an embodiment of the present disclosure. FIG. 4 depicts the counting scheme set in the second counting module to adapt to the sliding counting window. Because the aforementioned counted number is not cleared but a certain value is subtracted, after sliding to the next window, an adaptation should also be made for the counting starting point of each neuron in the output layer such that the counting could start from a new counting starting point (instead of being forced to zero). If a spike event is effectively counted by 4 consecutive sliding counting windows (for example, subtracting the first counted number/4 or the second counted number/4 each time, then it will completely slide through a certain window after 4 times. It is shown as a certain counted number in the sub-counter, and it is removed after 4 summation statistics. For example, a certain counted number in t4-t1′ is shown until a total of 4 sliding windows from W1 to W4 are slid), then 4 sub-counters (recorded as sub-counts 1˜4) are arranged correspondingly to each neuron in the output layer, and each sub-counter corresponds to ¼ sliding windows. FIG. 4 exemplarily shows that the output layer of the spiking neural network has 3 neurons, where the black circle, the white circle and the gray circle respectively represent the first neuron, the second neuron and the third neuron in the output layer. Furthermore, the first neuron corresponds to category 1, the second neuron corresponds to category 2, and the third neuron corresponds to category 3.

In an embodiment, when the window is slid once, the earliest counted sub-number 1 is removed and other sub-numbers are sequentially shifted (as shown in FIG. 4, they are moving to the left in the figure), and the new sub-number is moved into the sub-count 4. The number obtained by adding all the 4 sub-numbers is the spike event number corresponding to the neuron in the output layer under the current window. For example, for a certain neuron in the output layer, its sub-number 1+sub-number 2+sub-number 3+sub-number 4=the counted number of the neuron. For example, the counted number 1, counted number 2, and counted number 3 respectively correspond to three different neurons in the output layer. After sliding the window once, if ¼ window is moved, then the counted number of the neuron corresponding to the moved window=sub-number 2+sub-number 3+sub-number 4+new sub-number. In other words, the earliest counted number in the sub-counter is removed and the reset sub-counter (which can be the aforementioned sub-counter 1, or the sub-counter 4 after the shift) is used to count the new spike events.

Please refer to FIG. 3 again. After subtracting a certain value from the counted number of the first counting module or the total counted number of the second counting module, the counting window moves. At t2′, the subtracted value is supplemented by the new counted number, so a decision is made at t2′. For example, the counting window is moved to a time point between t2-t2′, such as the second counting window W2. Similarly, decisions are also made at t3′ and t4′, which respectively represent the counting windows of W3 and W4. Please note, due to the different occurrence rates of spike events, the aforementioned time intervals between t1—t4′, as shown in the figure, are not necessarily the same.

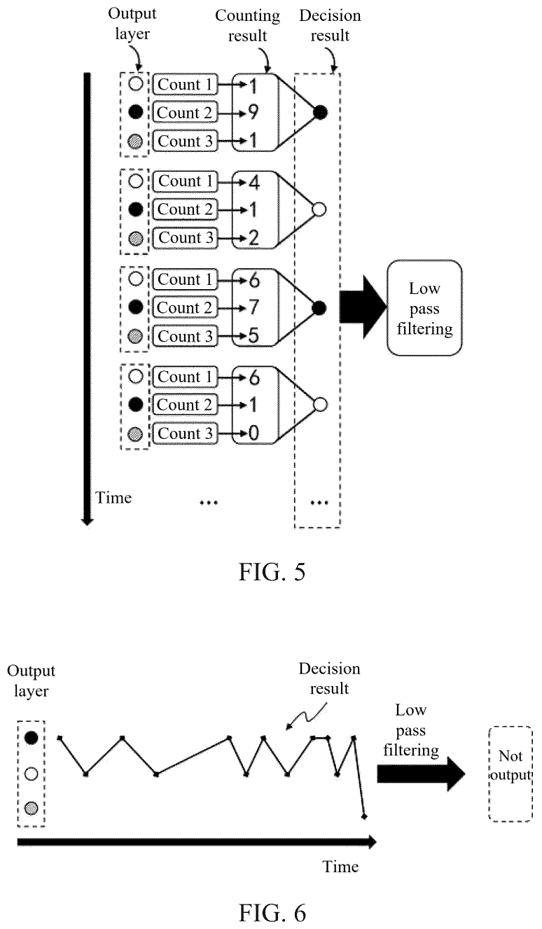

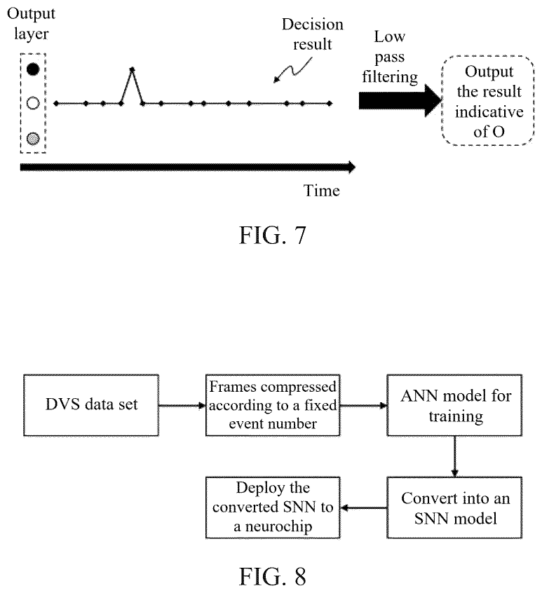

Please refer to FIGS. 5-7. FIG. 5 is a diagram of a decision-making scheme according to an embodiment of the present disclosure. FIG. 6 is a diagram of a high-frequency decision-making results that cannot pass through a low-pass filter according to an embodiment of the present disclosure. FIG. 7 is a diagram of a low-frequency decision-making results that pass through a low-pass filter according to an embodiment of the present disclosure.

In this embodiment, the output layer includes 3 neurons, as an example, where the black circle, the white circle and the gray circle respectively represent the first neuron, the second neuron and the third neuron in the output layer. Please refer to FIG. 5. According to the decision-making timing, the counting results are shown respectively. At each decision-making moment, a decision-making result is made according to the decision logic. In order to output more reliable results, a preferred scheme includes a low-pass filter device/step. The low pass filter could be implemented with software, hardware, or a combination of software and hardware. The low pass filter can be a part of the decision-making module or independent from the decision-making module. In addition, the low pass filter can be located inside the neuromorphic chip or outside the neuromorphic chip). The low pass filter is used to filter out unstable decision-making results. If the decision result repeatedly transits between different results in a continuous short period of time (that is, the decision result has changed), then such a result has high frequency characteristics, such as the decision result repeatedly transits between category 1 and category 2: 1-2-1-2-1-2-1-2-1-1-2-1-3 (as shown in FIG. 6). Then such a decision result, whose transition rate is not lower than the first threshold, cannot pass the low-pass filter. Therefore, this unreliable result will not be fired, or a result indicating that the decision-making result is uncertain will be fired. On the contrary, the decision-making result with the most occurrences among continuous a plurality of decision results should be fired.

If in a certain continuous short period of time, the decision-making module that generates a plurality of decision-making result relatively stably outputs a certain decision-making result, such as 2-2-2-2-1-2-2-2-2-2-2-2-2-2-2 (as shown in FIG. 7). This result has low-frequency characteristics and can pass through the low-pass filter. Accordingly, the most reliable result is fired, such as the category 2 represented by the corresponding neurons in the output layer.

Various means can be used to measure whether the output result is stable. These changes fall within the scope of the present disclosure. For example, the transitions of the decision-making results can be counted, and both the number of transitions and the transition rate can be used as the above indicators. For example, the aforementioned sequence of decision-making results that could not pass the low-pass filter had 11 transitions in the 13 decision-making results. However, in the aforementioned sequence of the decision-making results that can be low-passed by filter, there are 2 transitions in the 14 decision-making results.

In another embodiment, the decision-making result ratio can be used as the aforementioned indicator. In the aforementioned first example, the decision-making result has a ratio 54% for category 1 and a ratio 38% for category 2. In the second example, the decision-making result has a ratio 93% for category 2. If the set ratio is higher than the second threshold of 70%, the decision-making result with the most occurrences among the continuous decision results will be fired. If it is lower than 70%, the unreliable result will not be fired, or the decision indicating that the result is uncertain will be fired. In another embodiment, the above-mentioned first threshold and the second threshold can be used in combination. That is, only when both conditions of the first threshold and the second threshold are satisfied at the same time, then the decision-making result is fired.

Please refer to FIG. 8. FIG. 8 discloses a count-based spiking neural network training method and device. In this scheme, in order to match the above-mentioned decision-making scheme based on counting, a data set is generated according to the events collected by the event imaging device such as DVS, and then frames are compressed according to a fixed event number to form an image. And then, the image generated by the data set is fed into an artificial neural network (ANN) model for training. The present disclosure is not limited to a specific artificial neural network, so any suitable ANN model and its training method are applicable in the present disclosure, such as convolutional neural network and error backpropagation training. Then the ANN model is converted into an SNN model, which may involve quantization of weights, conversion of neuron models (such as activation functions) and other processes. The conversion from the ANN model to the SNN model is well known in the art. The implementation of the present disclosure is not limited. The trained neural network configuration parameters are eventually deployed to the neuromorphic chip. The chip obtains interference capabilities and can be put into practical application scenarios, such as gesture detection and fall detection. In other words, the present disclosure discloses a spike neural network training method. The method includes following steps: for the data set collected by the event imaging device, generating a plurality of images according to a fixed number of spike events; training an artificial neural network according to the plurality of images; converting an artificial neural network into a spiking neural network; and deploying the converted spiking neural network to the neuromorphic chip.

Another embodiment of the present disclosure is also directed to a spike event decision-making method, configured to make a decision based on output spike events of a spiking neural network in a neuromorphic chip. The method comprises: counting a number of input spike events of the spiking neural network to obtain a first count value; and generating a decision-making result according to counts of spike events of each of a plurality of neurons in an output layer of the spiking neural network when the first count value reaches a first predetermined value; or counting a number of output spike events of some or all neurons in the output layer of the spiking neural network to obtain a second count value; and generating a decision-making result according to counts of spike events of each of the neurons in an output layer of the spiking neural network when the second count value reaches a second predetermined value.

In some embodiments, there is at least a partial overlap between the input spike events corresponding to the first count value obtained twice when two adjacent decision-making results are made; or/and, use a plurality of sub-counter to count each spike event emitted by some or all neurons of the output layer; remove the earliest count in the sub-counter, and use the zeroed sub-counter to count the newly issued spike events; the sum of counts in all sub-counters corresponding to each neuron in the output layer is used as the count on which the decision result is based.

According to another embodiment, a chip deploying a spike neural network is provided. The chip includes a spike event decision-making device as provided above, or performs a spike event decision-making method as provided above. The spike event decision-making device or spike event decision-making method is configured to make decisions on the output spike event of the spike neural network.

According to another embodiment, an electronic device includes an event imaging device and a spike event decision-making device as provided above or a chip as provided above, or performs a spike event decision-making method as provided above. The spike event decision-making device, the chip or the spike event decision-making method is configured to make decisions on the output spike event processed by the event imaging device.

Although the present disclosure has been described with reference to specific features and embodiments of the present disclosure, various modifications and combinations may be made without departing from the present disclosure. Accordingly, the description and drawings should simply be regarded as descriptions of some embodiments of the present disclosure limited by the claims and are expected to cover any and all modifications, variations, combinations or equivalents falling within the scope of the present disclosure. Thus, although the present disclosure and its advantages have been described in detail, various modifications, substitutions and alterations may be made without departing from the present disclosure limited by the appended claims. Further, the scope of the present disclosure is not intended to be limited to specific embodiments of processes, machines, manufactures, compositions of substances, devices, methods and steps described in the specification.

Those of ordinary skill in the art will be easily understood from the disclosure of the present disclosure, and may perform substantially the same function or substantially the same result as described herein according to the present disclosure or a process, machine, manufacture, material composition, apparatus, method or step developed herein. Accordingly, the scopes of claims are intended to include such a process, machine, manufacture, material composition, device, method or step.

In order to achieve better technical results or for the needs of certain applications, those skilled in the art may make further improvements to the technical solution on the basis of the present disclosure. However, even if the part of the improvement/design is inventive or/and creative, as long as the technical features covered by the claims of the present disclosure are utilized, the technical solution should also fall within the scope of the present disclosure according to the “principle of universal coverage.”

Certain technical features defined in the claims may have alternative technical features, or the order of certain technical processes and the order of material organization may be reorganized. After reading the embodiments of the present disclosure, it is easy for those of ordinary skill in the art to think of these alternatives, or change the order of the technical process and the order of material organization, and then use basically the same means, solve the basically same technical problems, and achieve basically the same technical effect. Even if the limitations of the claims clearly define the above means or/and order, but these modifications, changes, replacements, should fall into the scope of the claims in accordance with the “Doctrine of Equivalents”.

For the claims define a clear numerical limit, those skilled in the art can generally understand that other reasonable values near the value can also be applied to a specific embodiment. These design solutions that are not detached from the idea of the present disclosure also fall within the scope of the claims.

In conjunction with the various method steps and units described in the embodiments disclosed herein, it can be achieved by electronic hardware, computer software, or in a combination thereof. In order to clearly illustrate the interchangeability of hardware and software, the steps and composition of each embodiment have been described in accordance with their functions in the description. Whether these functions are performed in hardware or software depends on the specific application and design constraints of the technical solution. Those of ordinary skill in the art may use different methods for each particular application to achieve the described functions, but such implementation should not be beyond the scope of the claim of the present disclosure.

1. A spike event decision-making device, configured to make a decision based on output spike events of a spiking neural network in the neuromorphic chip, the spike event decision-making device comprising:
a first counting module, configured to count a number of input spike events of the spiking neural network; and
a decision-making module is configured to generate a decision-making result according to numbers of spike events fired by a plurality of neurons in an output layer of the spiking neural network when the number counted by the first counting module reaches a first predetermined value.

2. The spike event decision-making device of claim 1, further comprising:
a second counting module, configured to perform one of following operations to count the numbers of spike events fired by the plurality of neurons in the output layer of the spiking neural network:
(i) counting spikes fired by each neuron in the output layer, and adding them up to obtain a total count of the spikes fired by a part or all neurons in the output layer;
(ii) counting spikes fired by a plurality of neurons in the output layer to obtain the total count; and
(iii) counting spikes fired by each neuron in the output layer without adding them up.

3. The spike event decision-making device of claim 1, wherein the decision-making module is further configured to make a decision when the number counted by the first counting module reaches the first predetermined value or when the count of the first count module reaches the first predetermined value and when a number counted by the second counting module reaches a second predetermined value.

4. The spike event decision-making device of claim 1, wherein when there are at least two successive decision-making results, there is a partial overlap between the input spike events corresponding to the two corresponding numbers counted by the first counting module; and/or, there is partial overlap between the spike events fired by the neurons in the output layer of the spiking neural network corresponding to the two corresponding numbers counted by the second counting module.

5. The spike event decision-making device of claim 2, wherein the second counting module uses a plurality of sub-counter to count spike events fired by each of the plurality of neurons in the output layer, to remove an earliest count in the sub-counter, and to use a zeroed sub-counter to count new spike events; and a sum of counts in all sub-counters corresponding to each neuron in the output layer is used as a count on which the decision-making result is based.

6. The spike event decision-making device of claim 1, wherein when a plurality of successive decision-making results meet one or a plurality of conditions below, then outputting a decision-making result with the largest number of occurrences in the successive decision-making results:
(i) when a transition rate or a number of transitions of the successive decision-making results is lower than a first threshold; and
(ii) when a ratio of the decision result with the most occurrences to the successive decision-making results is higher than a second threshold;
otherwise, stopping outputting any decision result or outputting the decision result with an uncertain indication result.

7. The spike event decision-making device of claim 1, wherein one or more of the first counting module, and the decision-making module is implemented inside or outside the neuromorphic chip.

8.-11. (canceled)

12. A spike event decision-making method, configured to make a decision based on output spike events of a spiking neural network in a neuromorphic chip, the method comprising:
counting a number of input spike events of the spiking neural network to obtain a first count value; and generating a decision-making result according to counts of spike events of each of a plurality of neurons in an output layer of the spiking neural network when the first count value reaches a first predetermined value; or
counting a number of output spike events of some or all neurons in the output layer of the spiking neural network to obtain a second count value; and generating a decision-making result according to counts of spike events of each of the neurons in an output layer of the spiking neural network when the second count value reaches a second predetermined value.

13. The method of claim 12, wherein there is at least a partial overlap between the input spike events corresponding to the first count value obtained twice when two adjacent decision-making results are made; or/and,
use a plurality of sub-counter to count each spike event emitted by some or all neurons of the output layer; remove the earliest count in the sub-counter, and use the zeroed sub-counter to count the newly issued spike events; the sum of counts in all sub-counters corresponding to each neuron in the output layer is used as the count on which the decision result is based.

14. A chip deploying a spike neural network, comprising a spike event decision-making device, wherein the spike event decision-making device is configured to make decisions on output spike events of the spike neural network by an event imaging device, the spike event decision-making device comprising:
a first counting module, configured to count a number of input spike events of the spiking neural network; and
a decision-making module is configured to generate a decision-making result according to numbers of spike events outputted by a plurality of neurons in an output layer of the spiking neural network when the number counted by the first counting module reaches a first predetermined value.

15. (canceled)

16. The chip of claim 14, wherein spike event decision-making device further comprises:
a second counting module, configured to perform one of following operations to count the numbers of spike events outputted by the plurality of neurons in the output layer of the spiking neural network:
(i) counting spikes outputted by each neuron in the output layer, and adding them up to obtain a total count of the spikes outputted by a part or all neurons in the output layer;
(ii) counting spikes outputted by a plurality of neurons in the output layer to obtain the total count; and
(iii) counting spikes outputted by each neuron in the output layer without adding them up.

17. The chip of claim 14, wherein the decision-making module is further configured to make a decision when the number counted by the first counting module reaches the first predetermined value or when the count of the first count module reaches the first predetermined value and when a number counted by the second counting module second count module reaches a second predetermined value.

18. The chip of claim 14, wherein when there are at least two successive decision-making results, there is a partial overlap between the input spike events corresponding to the two corresponding numbers counted by the first counting module; and/or, there is partial overlap between the spike events outputted by the neurons in the output layer of the spiking neural network corresponding to the two corresponding numbers counted by in the second counting module.

19. The chip of claim 14, wherein the second counting module uses a plurality of sub-counter to count spike events outputted by each of the plurality of neurons in the output layer, to remove an earliest count in the sub-counter, and to use a zeroed sub-counter to count new spike events; and a sum of counts in all sub-counters corresponding to each neuron in the output layer is used as a count on which the decision-making result is based.

20. The chip of claim 14, wherein when a plurality of successive decision-making results meet one or a plurality of conditions below, then outputting a decision-making result with the largest number of occurrences in the successive decision-making results:
(i) when a transition rate or a number of transitions of the successive decision-making results is lower than a first threshold; and
(ii) when a ratio of the decision result with the most occurrences to the successive decision-making results is higher than a second threshold;
otherwise, stopping outputting any decision result or outputting the decision result with an uncertain indication result.

21. The chip of claim 16, wherein one or more of the first counting module, the second counting module, and the decision-making module is implemented inside or outside the neurochip.
